(19) United States
(12) Patent Application Publication
(10) Pub. No.: US 2025/0279728 A1
(43) Pub. Date: Sep. 4, 2025

(54) PRE-CHARGING ARRANGEMENT, POWER CONVERTER SYSTEM, AND METHOD FOR PRE-CHARGING POLY-PHASE POWER CONVERTER

(71) Applicant: Vacon Oy, Vaasa (FI)

(72) Inventors: Stefan Schroeder, Munich (DE); M A Awal, Nordborg (DK)

(21) Appl. No.: 19/020,380

(22) Filed: Jan. 14, 2025

(30) Foreign Application Priority Data
Feb. 29, 2024 (DE) 102024105831.5

(51) Int. Cl. H02M 7/217; H02M 1/00; H02M 1/08; H02M 7/487

(52) U.S. Cl. CPC H02M 7/2173; H02M 1/007; H02M 1/08; H02M 7/487

(57) ABSTRACT

A pre-charging arrangement (10) for a poly-phase power converter (20), optionally an H-bridge converter, is arranged for being supplied by a poly-phase AC power supply (40) via an input filter (30), wherein the poly-phase power converter (20) is arranged to be connected to and disconnected from the poly-phase AC power supply (40) by a first circuit breaker (35). The pre-charging arrangement (10) includes an AC power supply (12) connected via a transformer (14), having a primary side (14A) and a secondary side (14B), between a first common point (39) of the input filter (30) and a second common point (29) of the poly-phase power converter (20) for pre-charging DC link capacitors (25) of the poly-phase power converter (20), and a second circuit breaker (15) for connecting and disconnecting the pre-charging arrangement (10).

### CROSS-REFERENCE TO RELATED APPLICATION

This application claims foreign priority benefits under 35 U.S.C. § 119 to German Patent Application No. 102024105831.5 filed on Feb. 29, 2024, the content of which is hereby incorporated by reference in its entirety.

### TECHNICAL FIELD

The present invention relates in general to power converters, such as frequency converters, inverters, or rectifiers. In particular, however, not exclusively, the present invention concerns pre-charging arrangements and methods for pre-charging poly-phase power converters, and utilization thereof in power converter systems. Such pre-charging arrangements and methods, and power converter systems may be used, for example, in battery energy storage systems, electric vehicle charging systems, power-to-X (especially hydrogen) electrolyser systems, and/or widely in frequency converter systems.

### BACKGROUND

Without pre-charging, the current of power converter becomes at least momentarily very high when being connected to the grid or AC (alternating current) power supply in order to start normal operation. In existing pre-charge strategies for poly-phase converter topologies, especially for H-bridge rectifiers, a large number of pre-charge circuits, such as separate pre-charge circuits including a diode or switch rectifier for each H-bridge DC bus, are needed. This is costly and adds complexity to the systems. In addition to H-bridge converter topologies, the problem with very high current applies also to other power converter topologies. There is, thus, still a need to develop pre-charging arrangements and methods for power converters.

### SUMMARY

An objective of the present invention is to provide a pre-charging arrangement, a power converter system, and a method for pre-charging a poly-phase power converter. Another objective of the present invention is that the pre-charging arrangement, the power converter system, and the method simplify pre-charging of the DC link capacitors of poly-phase power converters.

The objectives of the invention are reached by a pre-charging arrangement, a power converter system, and a method for pre-charging a poly-phase power converter as defined by the respective independent claims.

According to a first aspect, a pre-charging arrangement for a poly-phase power converter is provided. The poly-phase power converter is arranged for being supplied by a poly-phase AC power supply via an input filter, wherein the poly-phase power converter is arranged to be connected to and disconnected from the poly-phase AC power supply by a first circuit breaker.

The pre-charging arrangement comprises an AC power supply connected via a transformer, having a primary side and a secondary side, between a first common point of the input filter, preferably a star point formed by interconnected terminals of filter capacitors, and a second common point of the poly-phase power converter for pre-charging DC link capacitors of the poly-phase power converter. In addition, the pre-charging arrangement comprises a second circuit breaker or contactor for connecting and disconnecting the pre-charging arrangement.

The power converter may be, for example, a poly-phase H-bridge converter or a neutral point clamped (NPC) power converter.

In case of a poly-phase H-bridge converter, there may be one or several (cascaded) H-bridges per phase. The second common point in said cases is, preferable, the point where the (cascaded) H-bridge(s) from each phase (or phase legs) are connected to each other, thus forming a star point.

In case of an NPC power converter, the second common point is, preferable, the neutral point or the DC midpoint (a point between series connected DC link capacitors) of the converter. An NPC power converter preferably comprises at least two series connected DC link capacitors.

A DC bus or buses of the converter, preferably, include one or several DC link capacitors. There may be one DC link capacitor per DC bus, or several DC link capacitors connected in series and/or parallel per DC bus. The amount and connections between the DC link capacitors depend on the desired charging capacity and/or voltage level.

In various preferable embodiments, the pre-charging arrangement is configured to open the second circuit breaker after the pre-charging, and, subsequently, close the first circuit breaker for initiating a normal operation of the poly-phase power converter.

In various embodiments, the pre-charging arrangement, specifically the secondary side of the transformer thereof, may be connected between two star-points on the input side of the poly-phase power converter, namely the star-point of the filter capacitors of the input filter, and the star-point of the phase legs or the neutral point of the power converter.

The AC power supply may be a single-phase electric grid. For example, the primary side of the transformer may be connected between the line and the zero of the single-phase electric grid.

Alternatively or in addition, the AC power supply may comprise a pulse-width modulated (PWM) power supply connected via the transformer, preferably connected at the primary side thereof. Furthermore, the pulse-width modulated power supply may be configured to ramp-up a pre-charging voltage in accordance with a pre-defined slope. For example, a PWM regulated power-electronics converter may be used to act as an AC supply enabling controlled ramp-up/ramp-down of the AC voltage magnitude and/or frequency.

The primary side of the transformer may be connected to the AC power supply, and the secondary side of the transformer between the first common point and the second common point.

The poly-phase power converter as it is referred herein preferably comprises a plurality of phase legs, each one of the phase legs comprising a first terminal and a second terminal. The first terminals may be connected to respective phases of the poly-phase AC power supply and the second terminals are connected to the second common point. In case of a poly-phase cascaded H-bridge converter, there is a plurality of H-bridges connected in series between the first and second terminals in each phase leg.

The input filter preferably comprises at least a plurality of filter capacitors comprising first and second terminals, wherein the first terminals of the filter capacitors are connected to respective phases of the poly-phase AC power supply and the second terminals of the filter capacitors are connected to the first common point.

In some embodiments, the input filter is an LCL filter comprising the first common point at the second terminals of the filter capacitors.

Regarding the transformer, a turns ratio thereof, being a ratio of primary side turns to secondary side turns, is less than one. It may be even less than 0.8, 0.5, or 0.1, or even 0.01.

The transformer may be adapted to exhibit, during use thereof, a low voltage at the primary side. Said low voltage may be in the range from 100 V AC to 600 V AC, or even up to 1000 V AC, for instance, between the line and the neutral. Furthermore, the transformer may be adapted to exhibit, during use thereof, a medium or high voltage at the secondary side. Said medium voltage may be in the range from 1000 V AC or 1500 V AC up to 10000 or even 20000 V AC, for instance, between the line and the neutral. Said high voltage may be in the range from 10000 V AC upwards, for instance, between the line and the neutral.

In some embodiments, the transformer may be a double-winding or a multi-winding (more than two) transformer to combine power flow among different phases in poly-phase applications.

The second circuit breaker may, preferably, be arranged on the primary side of the transformer. Thus, there is no need to have a medium or high voltage feed and contactor for the pre-charging arrangement, if the transformer is as described above, that is, having lower voltage on the primary than on the secondary side.

The first circuit breaker may be arranged between the poly-phase AC power supply and the input filter.

A common mode filter comprising a plurality of filter inductors may be connected between the input filter and the poly-phase H-bridge converter. The common mode filter may be of the type L, LC, LCL, or LLCL, for instance, where L refers to inductors and C to capacitors of the filter, as is understood by a skilled person.

According to a second aspect, a power converter system is provided. The power converter system comprises a poly-phase power converter, optionally a (cascaded) H-bridge converter, for being supplied by a poly-phase AC power supply, an input filter for the poly-phase power converter, the input filter comprising a first common point, and a first circuit breaker for connecting and disconnecting the poly-phase power converter and the input filter from the poly-phase AC power supply. The power converter system also comprises the pre-charging arrangement in accordance with the first aspect and/or any embodiment thereof as described in this document.

According to a third aspect, a method for pre-charging a poly-phase power converter is provided. The poly-phase power converter, optionally a (cascaded) H-bridge converter, is arranged to be supplied by a poly-phase AC power supply via an input filter, the input filter comprising a first common point, wherein the poly-phase power converter and the input filter are arranged to be connected and disconnected by a first circuit breaker. The method comprises pre-charging DC buses, preferably including one or several DC link capacitors therein, of the poly-phase power converter by electrical energy from an AC power supply via a transformer, having a primary side and a secondary side, connected between the first common point of the input filter and a second common point of the poly-phase power converter. The DC buses may, thus, comprise one or several DC link capacitors connected in series and/or parallel with each other.

In preferable embodiments, the method comprises closing a second circuit breaker to connect an AC power supply via a transformer, having a primary side and a secondary side, between the first common point of the input filter and a second common point of the poly-phase power converter for pre-charging DC link capacitors of the poly-phase power converter, and opening the second circuit breaker after the pre-charging.

The method may also comprise closing the first circuit breaker after the opening to initiate a normal operation of the poly-phase power converter.

The method may also comprise opening the second circuit breaker and then operating, such as pulsing or modulating, the power converter such that the filter input voltage gets synchronized with the grid. When the filter input voltage matches the grid in amplitude, frequency, and phase, that is it has been synchronized, the first circuit breaker may be closed.

The present invention provides a pre-charging arrangement, a power converter system, and a method for pre-charging a poly-phase power converter poly-phase power converter. The present invention provides advantages over known solutions in that it allows the use of a single pre-charge unit for the many DC buses in the poly-phase power converter resulting in substantial reduction in cost, size, and complexity of the system.

Various other advantages will become clear to a skilled person based on the following detailed description.

The expression “a number of” may herein refer to any positive integer starting from one (1).

The expression “a plurality of” may refer to any positive integer starting from two (2), respectively.

The terms “first” and “second” are herein used to distinguish one element from another element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in the appended patent claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF THE DRAWINGS

Some embodiments of the invention are illustrated by way of example, and not by way of limitation, in the figures of the accompanying drawings.

FIG. 1 illustrates schematically a pre-charging arrangement in connection with a poly-phase power converter.

FIG. 2 illustrates schematically a pre-charging arrangement in connection with a poly-phase power converter.

FIGS. 3A and 3B illustrates schematically H-bridge circuits.

FIG. 4 illustrates schematically a pre-charging arrangement in connection with a poly-phase power converter.

FIGS. 5A and 5B illustrate schematically AC power supplies of pre-charging arrangements.

FIGS. 6A and 6B shows graphs of pre-charging voltages and currents.

FIG. 7 shows a flow diagram of a method.

FIG. 8 illustrates schematically a pre-charging arrangement in connection with a poly-phase power converter.

### DETAILED DESCRIPTION

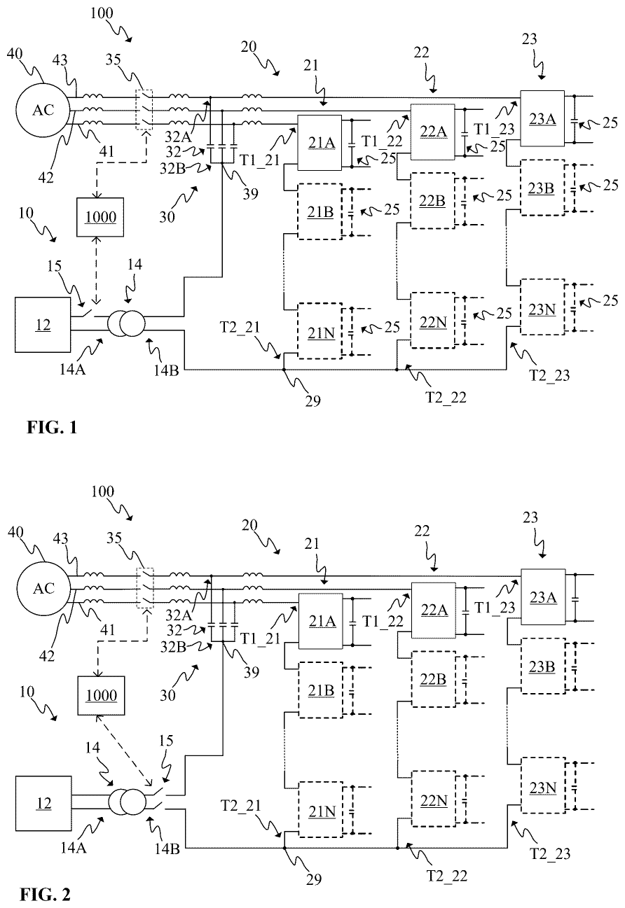

FIG. 1 illustrates schematically a pre-charging arrangement 10 for a poly-phase, optionally (cascaded) H-bridge, power converter 20, such a three-phase cascaded H-bridge converter, arranged for being supplied by a poly-phase AC power supply 40 via an input filter 30. Furthermore, the poly-phase, optionally (cascaded) H-bridge, converter 20 is arranged to be connected to and disconnected from the poly-phase AC power supply 40 by a first circuit breaker 35. The poly-phase power converter 20 may comprise one or a plurality of H-bridge circuits 21A-23N or other switching circuits in its plurality of phase legs 21-23.

The pre-charging arrangement 10 comprises an AC power supply 12 connected via a transformer 14, having a primary side 14A and a secondary side 14B, between a first common point 39 of the input filter 30 and a second common point 29 of the poly-phase, optionally (cascaded) H-bridge, converter 20 for pre-charging DC link capacitors 25 of the poly-phase power converter 20. The pre-charging arrangement 10 also comprises a second circuit breaker 15 for connecting and disconnecting the pre-charging arrangement 10.

Not depicted in the illustrations, the electronic circuit may incorporate a fuse connected in series with each AC power supply/poly-phase. This fuse is designed to break the power supply if the current surpasses a threshold defined by the fuse and its responsiveness. The fuse can be triggered to break in response to a fault condition in the power converter or any of the H-bridges, if any.

The pre-charging arrangement 10 and/or the poly-phase power converter 20 may comprise a control unit 1000, such as comprising a processing unit and a memory, as well as inputs and outputs for receiving data, such as measurement data, and for outputting command signals, such as to open and/or close circuit breakers 15, 35. The control unit 1000 may only control the pre-charging or, optionally, also the poly-phase power converter 20. Alternatively, there may be dedicated control units for both of them. In some cases, the control unit 1000 is comprised in the poly-phase power converter 20 and is arranged to control the pre-charging also.

In addition, the pre-charging arrangement 10 may be configured to open the second circuit breaker 15 after the pre-charging, and, subsequently, close the first circuit breaker 35 for initiating a normal operation of the poly-phase power converter 20.

In addition, preferably, the pre-charging arrangement 10 may be configured to close the second circuit breaker 15 to initiate the pre-charging. In such cases, the pre-charging arrangement 10 may be configured to keep the first circuit breaker 35 open, or even actively prevent it from being closed during the pre-charging.

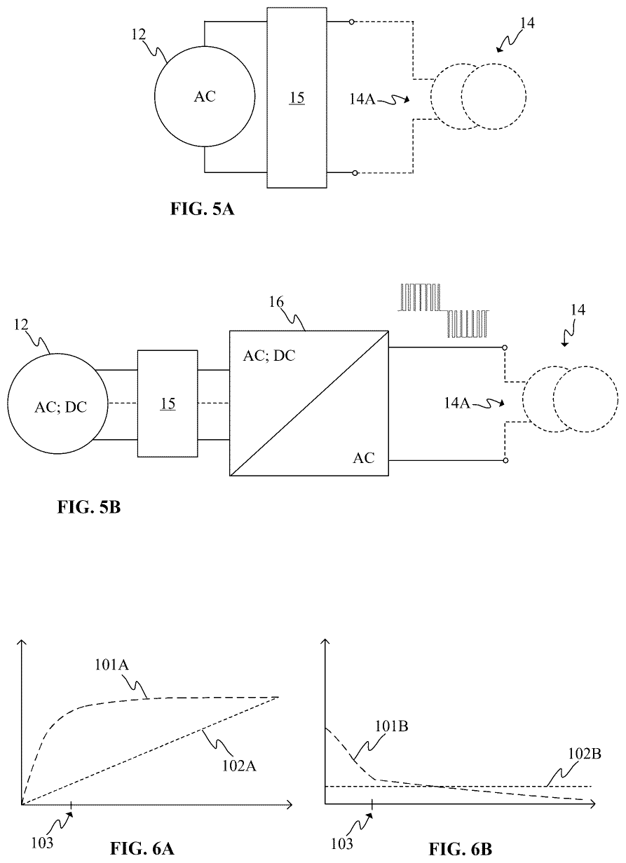

The AC power supply 40 may be a single-phase electric grid as illustrated in FIG. 5A. The primary side 14A of the transformer 14 may be connected between the line and the zero of the single-phase electric grid.

In addition or alternatively, the AC power supply 40 may comprise or be a pulse-width modulated power supply 16 connected to the transformer 14. This is illustrated in FIG. 5B. The pulse-width modulated power supply 16 may be configured to ramp-up pre-charging voltage in accordance with a pre-defined slope.

Furthermore, the primary side 14A of the transformer 14 may be connected to the AC power supply 12, and the secondary side 14B of the transformer 14 between the first common point 39 and the second common point 29.

The poly-phase power converter 20 may comprise a plurality of phase legs 21-23, each one of the phase legs 21-23 comprising a first terminal T1_21-T1_23 and a second terminal T2_21-T2_23, and, optionally, one or a plurality of H-bridges 21A-21N, 22A-22N, 23A-23N or other switching circuits/bridges connected in series between the first T1_21-T1_23 and second terminals T2_21-T2_23, wherein the first terminals T1_21-T1_23 are connected to respective phases 41-43 of the poly-phase AC power supply 40 and the second terminals T2_21-T2_23 are connected to the second common point 29. In case of having a plurality of H-bridges 21A-21N, 22A-22N, 23A-23N connected in series between the first T1_21-T1_23 and second terminals T2_21-T2_23, the converter 20 may be called a poly-phase cascaded H-bridge converter 20.

The input filter 30 may comprise at least a plurality of filter capacitors 32 comprising first 32A and second terminals 32B, wherein the first terminals 32A of the filter capacitors 32 are connected to respective phases 41-43 of the poly-phase AC power supply 40 and the second terminals 32B of the filter capacitors 32 are connected to the first common point 39 and/or to form the first common point 39.

In some embodiments, the input filter 30 may be an LCL filter comprising the first common point 39 at the second terminals 32B of the filter capacitors 32.

A turns ratio of the transformer 14, being a ratio of primary side turns to secondary side turns, may be less than one. It may be even less than 0.8, 0.5, or 0.1, or even 0.01.

The transformer may be adapted to exhibit, during use thereof, a low voltage at the primary side. Said low voltage may be in the range from 100 V AC to 600 V AC, or even up to 1000 V AC, for instance, between the line and the neutral. Furthermore, the transformer may be adapted to exhibit, during use thereof, a medium or high voltage at the secondary side. Said medium voltage may be in the range from 1000 V AC or 1500 V AC up to 10000 or even 20000 V AC, for instance, between the line and the neutral. Said high voltage may be in the range from 10000 V AC upwards, for instance, between the line and the neutral.

The second circuit breaker 15 may be arranged on the primary side 14A of the transformer 14 as shown in FIG. 1. Thus, the second circuit breaker 15 may be a low voltage circuit breaker. There is thus no need to add medium or high voltage circuit breakers to the power converter system 100 in order to perform the pre-charging.

Regarding the first circuit breaker 35, it may, preferably, be arranged between the poly-phase AC power supply 40 and the input filter 30.

FIG. 2 illustrates schematically a pre-charging arrangement 10 in connection with a poly-phase power converter 20. The pre-charging arrangement 10 may be otherwise similar to one shown in FIG. 1, however, the second circuit breaker 15 is arranged to the secondary side 14B of the transformer 14.

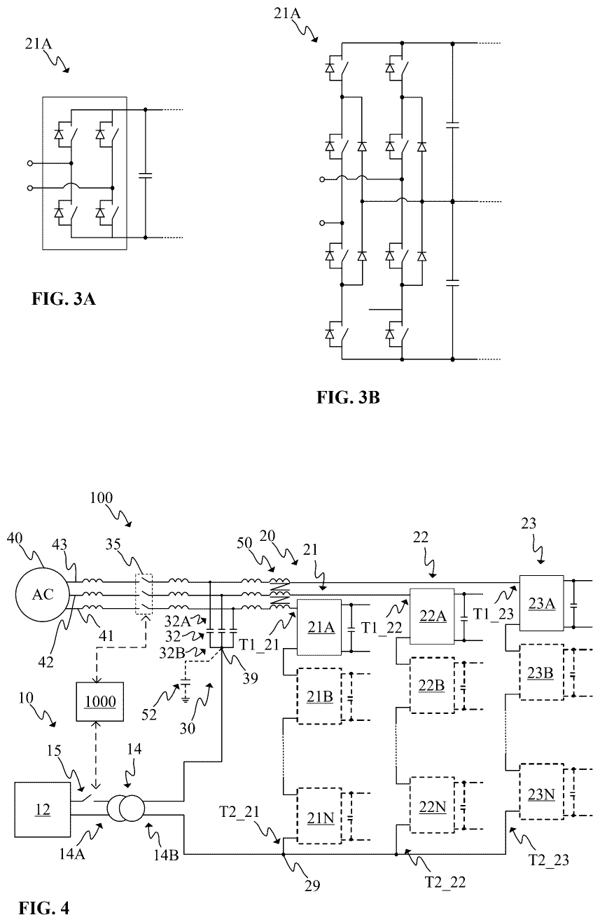

FIGS. 3A and 3B illustrates schematically H-bridges or H-bridge circuits 21A-23N. FIG. 3A illustrates a two-level H-bridge. FIG. 3B illustrates a three-level H-bridge. The present invention is not limited to two- and three-level H-bridges but may be implement-ed with H-bridges having any level, such as four-level, five-level, six-level etc. The H-bridges may comprise NP or NPC (Neutral Point Clamped) topologies.

FIG. 4 illustrates schematically a pre-charging arrangement 10 in connection with a poly-phase power converter 20. The pre-charging arrangement 10 may be similar to one shown in FIG. 1 or FIG. 2 but there is a common mode filter 50 comprising a plurality of filter inductors, such as coupled inductors, connected between the input filter 30 and the poly-phase power converter 20.

In various embodiments, such as illustrated in FIGS. 1, 2, and 4, the first common point 39 may be connected to the ground potential. The connection may be a low resistance or solid grounding connection, that is being more or less directly connected to grounding wire or the like. On the other hand, FIG. 4 illustrates, which may apply to other embodiments as well, a common mode capacitor 52 via which the first common point 39 may be grounded.

In view of the above, there is also disclosed herein a power converter system 100 comprising the poly-phase, optionally (cascaded) H-bridge, power converter 20 for being supplied by a poly-phase AC power supply 40, the input filter 30 for the poly-phase power converter 20, the input filter 30 comprising a first common point 39, the first circuit breaker 35 for connecting and disconnecting the poly-phase power converter 20 and the input filter 30 from the poly-phase AC power supply 40, and the pre-charging arrangement 10 as described herein above. The power converter system 100 may comprise its own control unit 1000, or the control unit 1000 may be comprised in the converter 20 and/or the pre-charging arrangement 10.

FIGS. 6A and 6B shows graphs of pre-charging voltages 101A, 102A and currents 101B, 102B. In embodiments with a single-phase electric grid as the AC power supply 12, the amplitude of the pre-charging voltage may be as shown by 101A. The pre-charging voltage 101A represents the voltage of the DC link capacitors 25 of the power converter 20 or of an H-bridge 21A-23N, or the series connection thereof. The pre-charging current in such case is shown by 101B. The pre-charging current 101B includes a higher value portion before time instance 103. After that the current stabilizes to a lower value.

In another examples, wherein the pre-charging arrangement 10 comprise a controllable AC power supply 12, such as a pulse-width modulated power supply 16, e.g. including a PWM regulated power converter, the pre-charging current 102B may be controlled so as not to become too high. As can be seen, marked by 102A, the pre-charging voltage then increases slower. The pulse-width modulated power supply 16 may thus be configured to ramp-up pre-charging voltage in accordance with a pre-defined slope.

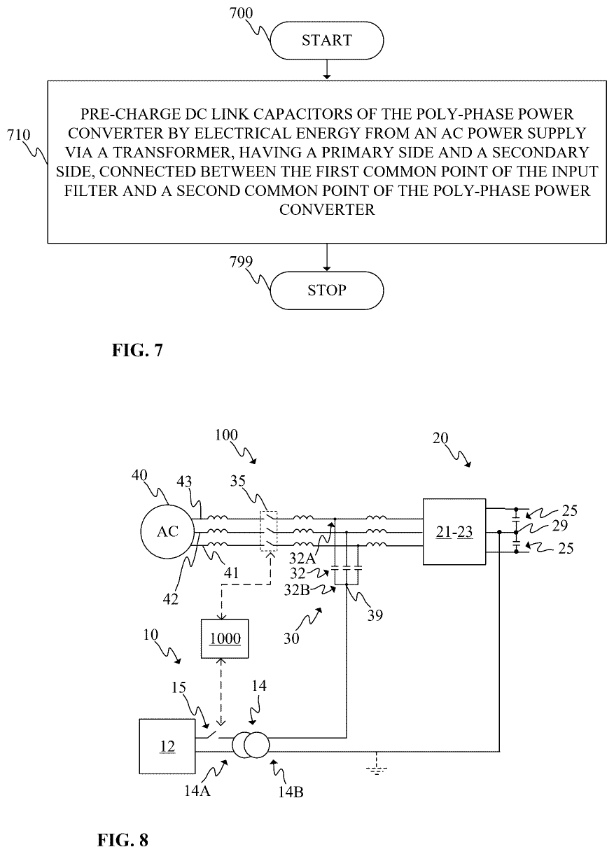

FIG. 7 shows a flow diagram of a method. The method is preferably for pre-charging a poly-phase, optionally (cascaded) H-bridge, power converter 20 arranged to be supplied by a poly-phase AC power supply 40 via an input filter 30, the input filter 30 comprising a first common point 39, and wherein the poly-phase power converter 20 and the input filter 30 are arranged to be connected and disconnected by the first circuit breaker 35.

Item or step 700 refers to an optional start-up phase of the method. Suitable equipment and components are obtained, and systems assembled and configured for operation.

The method steps may, in accordance with a non-limiting example, be performed by the control unit 1000 as described hereinabove, for instance.

Item or step 710 refers to pre-charging DC link capacitors 25 of the poly-phase power converter 20 by electrical energy from an AC power supply 12 via a transformer 14, having a primary side 14A and a secondary side 14B, connected between the first common point 39 of the input filter 30 and a second common point 29 of the poly-phase power converter 20.

In various embodiments, the pre-charging may comprise opening the second circuit breaker 15 after the pre-charging, and the method further comprises closing the first circuit breaker 35 after said opening to initiate a normal operation of the poly-phase power converter 20.

Furthermore, optionally, the pre-charging may comprise closing the second circuit breaker 15 to connect the AC power supply 12 via the transformer 14 between the first common point 39 and the second common point 29 to start pre-charging of the DC link capacitors 25 of the poly-phase converter 20.

In accordance with an embodiment, the method comprises, in stated the order:
1) closing the second circuit breaker or contactor 15,
2) charging the DC link capacitors 25 to a desired voltage level,
3) opening the second circuit breaker or contactor 15, and
4) closing the first circuit breaker (which has been open up to this step).

There may be an optional step 3b) after step 3) and before step 4), during which the input filter is synchronized with respect to the poly-phase AC power supply 40 as described hereinbefore.

After step 4) above, the normal operation may be started constituting to the end of the pre-charging.

Method execution may be stopped at item or step 799.

Term “normal operation of the poly-phase power converter” refers to operation of the poly-phase power converter 20 after the pre-charging during which the converter is, for example, utilized and operated to produce the desired voltage(s) and current(s) at its output. On the other hand, the normal operation may also include such that the poly-phase power converter 20 is not necessarily producing any voltage(s) and current(s) but it may only be configured to be ready to do so after the pre-charging, that is, the converter is in a ready state having the DC link capacitors 25 pre-charged suitably and/or to a pre-defined value, and having the first circuit breaker 35 closed.

FIG. 8 illustrates schematically a pre-charging arrangement 100 in connection with a poly-phase power converter 20. In FIG. 8, the power converter 20 may be an NPC power converter. As can be seen, the second common point 29 is the neutral point or the DC link midpoint of the power converter 20. The NPC power converter comprises a plurality of phase legs 21-23, however, they are not illustrated in detail in FIG. 8 for simplicity. The skilled person realizes that the power converter 20 as illustrated in FIG. 8 may comprise three phase legs 21-23 comprising controllable switching devices which are controlled, such as by utilizing a PWM technique, to produce desired DC output across the DC link capacitors 25. Thus, in some embodiments, it is not necessary to have separate switching circuits or bridges (such as shown in FIGS. 1, 2, and 4) for each phase.

As understood by the skilled person, the power converter 20 and/or the converter system 100 may comprise various sensors for measuring voltages and currents in the converter 20 and/or the system 100. For example, input and output voltages and currents, and DC bus voltages etc. The measurements may be received at the control unit 1000. Furthermore, the control unit 1000 may be adapted to control circuit breakers 15, 35 and optionally other devices/components.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A pre-charging arrangement for a poly-phase power converter arranged for being supplied by a poly-phase AC power supply via an input filter, wherein the poly-phase power converter is arranged to be connected to and disconnected from the poly-phase AC power supply by a first circuit breaker, wherein the pre-charging arrangement comprises:
an AC power supply connected via a transformer, having a primary side and a secondary side, between a first common point of the input filter and a second common point of the poly-phase power converter for pre-charging DC link capacitors of the poly-phase power converter, and
a second circuit breaker for connecting and disconnecting the pre-charging arrangement.

2. The pre-charging arrangement of claim 1, configured to:
open the second circuit breaker after the pre-charging, and, subsequently,
close the first circuit breaker for initiating a normal operation of the poly-phase power converter.

3. The pre-charging arrangement of claim 1, wherein the AC power supply is a single-phase electric grid.

4. The pre-charging arrangement of claim 1, wherein the AC power supply comprises a pulse-width modulated power supply connected to the transformer.

5. The pre-charging arrangement of claim 4, wherein the pulse-width modulated power supply is configured to ramp-up a pre-charging voltage in accordance with a pre-defined slope.

6. The pre-charging arrangement of claim 1, wherein the primary side of the transformer is connected to the AC power supply, and the secondary side of the transformer between the first common point and the second common point.

7. The pre-charging arrangement of claim 1, wherein the poly-phase power converter comprises a plurality of phase legs, each one of the phase legs comprising a first terminal (T1_21-T1_23) and a second terminal (T2_21-T2_23), and a plurality of H-bridges connected in series between the first (T1_21-T1_23) and second terminals (T2_21-T2_23), wherein the first terminals (T1_21-T1_23) are connected to respective phases of the poly-phase AC power supply and the second terminals (T2_21-T2_23) are connected to the second common point.

8. The pre-charging arrangement of claim 1, wherein the input filter comprises at least a plurality of filter capacitors comprising first (T1_21-T1_23) and second terminals (T2_21-T2_23), wherein the first terminals (T1_21-T1_23) of the filter capacitors are connected to respective phases of the poly-phase AC power supply and the second terminals (T2_21-T2_23) of the filter capacitors are connected to the first common point.

9. The pre-charging arrangement of claim 1, wherein a turns ratio of the transformer, being a ratio of primary side turns to secondary side turns, is less than one.

10. The pre-charging arrangement of claim 1, wherein the second circuit breaker is arranged on the primary side of the transformer.

11. The pre-charging arrangement of claim 1, wherein the first circuit breaker is arranged between the poly-phase AC power supply and the input filter.

12. The pre-charging arrangement of claim 1, wherein a common mode filter comprising a plurality of filter inductors is connected between the input filter and the poly-phase converter.

13. A power converter system, comprising:
a poly-phase power converter, such as an optionally cascaded, H-bridge converter, for being supplied by a poly-phase AC power supply,
an input filter for the poly-phase power converter, the input filter comprising a first common point,
a first circuit breaker for connecting and disconnecting the poly-phase power converter and the input filter from the poly-phase AC power supply, and
the pre-charging arrangement of claim 1.

14. A method for pre-charging a poly-phase power converter, such as an, optionally cascaded, H-bridge converter, arranged to be supplied by a poly-phase AC power supply via an input filter, the input filter comprising a first common point, wherein the poly-phase power converter and the input filter are arranged to be connected and disconnected by a first circuit breaker, the method comprising:
pre-charging DC link capacitors of the poly-phase power converter by electrical energy from an AC power supply via a transformer, having a primary side and a secondary side, connected between the first common point of the input filter and a second common point of the poly-phase power converter.

15. The method of claim 14, wherein the pre-charging comprises:
closing a second circuit breaker to connect an AC power supply via a transformer, having a primary side and a secondary side, between the first common point of the input filter and a second common point of the poly-phase power converter for pre-charging DC link capacitors of the poly-phase power converter, and
opening the second circuit breaker after the pre-charging, wherein, the method comprises
closing the first circuit breaker after the opening to initiate a normal operation of the poly-phase power converter.
